(19) United States
(12) Patent Application Publication
(10) Pub. No.: US 2014/0198195 A1
(43) Pub. Date: Jul. 17, 2014

(54) TERAHERTZ HEALTH CHECKER

(71) Applicant: Electronics and Telecommunications Research Institute, Daejeon (KR)

(72) Inventors: Dong Suk JUN, Daejeon (KR); Seok-Hwan MOON, Daejeon (KR); In-Kyu YOU, Daejeon (KR); Jae Ick CHOI, Daejeon (KR)

(73) Assignee: Electronics and Telecommunications Research Institute, Daejeon (KR)

(21) Appl. No.: 14/156,804

(22) Filed: Jan. 16, 2014

(30) Foreign Application Priority Data
Jan. 17, 2013 (KR) 10-2013-0005390
Oct. 18, 2013 (KR) 10-2013-0124408

(51) Int. Cl. H04N 5/33

(52) U.S. Cl. CPC H04N 5/33
USPC 348/77

(57) ABSTRACT

Provided is a terahertz health checker. The terahertz health checker includes a terahertz wave transmitter generating terahertz waves in a terahertz band, a lens outputting the terahertz waves and receiving terahertz waves reflected from the outputted terahertz waves, an imaging chip connected to the lens, detecting the received terahertz waves, and generating a digital image signal based on the detected terahertz waves, a readout circuit reading out the digital image signal, and a transceiver outputting the read-out digital image signal to the outside.

### CROSS-REFERENCE TO RELATED APPLICATIONS

This U.S. non-provisional patent application claims priority under 35 U.S.C. §119 of Korean Patent Application Nos. 10-2013-0005390, filed on Jan. 17, 2013, and 10-2013-0124468, filed on Oct. 18, 2013, the entire contents of which are hereby incorporated by reference.

### BACKGROUND OF THE INVENTION

The present disclosure herein relates to a detection and measurement system, and more particularly, to a terahertz health checker using a terahertz band.

Generally, there are many kinds of detection devices for detecting peripheral environments, objects, animals, human bodies. As an example, detection devices using X-rays may have bad effects on animals or human bodies due to radiation included in X-ray signals. Since visible rays have total reflection properties, it is difficult to use detection devices using visible rays. Due to peripheral environments or colors of targets to be detected, detection devices using infrared rays have a limitation in a detection distance. Also, detection devices using ultraviolet rays receive a great effect from an electric field and have severe fluctuation in noise according to size.

As an example, health checkers are used as detection devices for checking a physical condition of a human body. Due thereto, health checkers overcoming limitations of general detection devices and having high resolution, that is, high measuring performance are needed.

In addition, such health checkers may be used to frequently measure pulses, blood pressures, and cardiac impulses or may be used in situations such as occurrence of emergency patients. For this, health checkers have evolved to have easily portable small sized shapes. Accordingly, it is necessary to reduce a size of a health checker.

### SUMMARY OF THE INVENTION

The present disclosure provides a terahertz health checker having high resolution and using terahertz waves.

The present disclosure also provides a terahertz health checker having a small size.

Embodiments of the present invention provide terahertz health checkers including a terahertz wave transmitter generating terahertz waves in a terahertz band, a lens outputting the terahertz waves and receiving terahertz waves reflected from the outputted terahertz waves, an imaging chip connected to the lens, detecting the received terahertz waves, and generating a digital image signal based on the detected terahertz waves, a readout circuit reading out the digital image signal, and a transceiver outputting the read-out digital image signal to the outside.

In some embodiments, the digital image signal may be an image-shaped signal formed of digital signals 0 and 1 depending on whether terahertz waves detected from a detection area of the outputted terahertz waves are present or not.

In other embodiments, the terahertz health checker may further include a power supply circuit for supplying operating power to the terahertz transmitter, the imaging chip, the readout circuit, and the transceiver.

In still other embodiments, the terahertz health checker may further include a millimeter wave generator for generating and transmitting a millimeter wave signal, a lens outputting the generated millimeter waves and receiving millimeter waves corresponding to the outputted millimeter waves, and a millimeter wave camera outputting the received millimeter wave signal to the imaging chip.

In even other embodiments, the terahertz health checker may further include a lens for receiving visible rays and a video camera outputting the received visible rays to the imaging chip.

In yet other embodiments, the terahertz health checker may further include a lens for receiving infrared rays and an infrared camera outputting the received infrared rays to the imaging chip.

In further embodiments, the terahertz health checker may further include a lens for receiving ultraviolet rays and an ultraviolet camera outputting the received ultraviolet rays to the imaging chip.

In still further embodiments, the terahertz health checker may further include a signal processor processing the digital image signal and a display module displaying the signal-processed image.

In even further embodiments, the imaging chip may include a first field programmable gate array (FPGA) generating a row address, a row selection circuitry generating row bits using the row address, a terahertz wave detector detecting the terahertz waves, a differential cascade matching the detected terahertz waves with the row bits and outputting the same, a second FPGA generating a column address, a column selection circuitry generating column bits using the column address, matching the terahertz waves matched with the row bits with the column bits, and output the same, a sample hold amplifier amplifying a terahertz wave signal matched with the column bits and row bits and outputting the amplified signal using a holding operation according to an external control signal, and an A/D converter converting the amplified signal into a digital signal and outputting the digital signal.

In yet further embodiments, the imaging chip may further include an offset compensation circuitry compensating the differential cascade with an offset of the detected terahertz wave signal.

In much further embodiments, the imaging chip may include a first FPGA generating a column address, a column address decoder generating a column selection address using the column address, a current mirror circuit receiving a reference current and providing a current signal for detecting terahertz waves, a terahertz wave detector detecting the received terahertz waves based on the current signal and the column selection address, a second FPGA generating a row address, a row address decoder generating a row selection address using the row address and outputting the detected terahertz waves using the row selection address, an analog multiplexer multiplexing and outputting the outputted terahertz waves by operating in one of a serial mode and a parallel mode, and a serial-parallel mode controller controlling operations of the row address decoder and the analog multiplexer as one of the serial mode and parallel mode.

In still much further embodiments, the terahertz wave detector may include a plurality of terahertz wave detecting devices. The terahertz wave detecting device may include an antenna detecting the terahertz waves, a switch receiving the current signal through a drain and operating according to the column selection address inputted through a gate, a capacitor whose one end is connected to a source of the switch and another is grounded, and a Shottky diode whose anode is connected to a contact point between the one end of the capacitor and an output of the antenna, the Shottky diode outputting the terahertz waves detected by the antenna through a cathode thereof.

In even much further embodiments, the imaging chip may further include a plurality of buffers providing the terahertz wave detecting devices with outputs of the column address decoder, respectively and a plurality of amplifiers amplifying a plurality of outputs of the row address decoder.

In other embodiments of the present invention, terahertz health checkers include a lens receiving terahertz waves, an imaging chip connected to the lens, detecting the received terahertz waves, and generating a digital image signal based on the detected terahertz waves, and a readout circuit reading out the digital image signal. In this case, the imaging chip includes a first FPGA generating a row address, a row selection circuitry generating row bits using the row address, a terahertz wave detector detecting the terahertz waves, a differential cascade matching the detected terahertz waves with the row bits and outputting the same, a second FPGA generating a column address, a column selection circuitry generating column bits using the column address, matching the terahertz waves matched with the row bits with the column bits, and output the same, a sample hold amplifier amplifying a terahertz wave signal matched with the column bits and row bits and outputting the amplified signal using a holding operation according to an external control signal, and an A/D converter converting the amplified signal into a digital signal and outputting the digital signal.

In some embodiments, the digital image signal may be an image-shaped signal formed of digital signals 0 and 1 depending on whether terahertz waves detected from a detection area of the outputted terahertz waves are present or not.

In other embodiments, the imaging chip may further include an offset compensation circuitry compensating the differential cascade with an offset of the detected terahertz wave signal.

In still other embodiments of the present invention, terahertz health checkers include a lens receiving terahertz waves, an imaging chip connected to the lens, detecting the received terahertz waves, and generating a digital image signal based on the detected terahertz waves, and a readout circuit reading out the digital image signal. In this case, the imaging chip includes a first FPGA generating a column address, a column address decoder generating a column selection address using the column address, a current mirror circuit receiving a reference current and providing a current signal for detecting terahertz waves, a terahertz wave detector detecting the received terahertz waves based on the current signal and the column selection address, a second FPGA generating a row address, a row address decoder generating a row selection address using the row address and outputting the detected terahertz waves using the row selection address, an analog multiplexer multiplexing and outputting the outputted terahertz waves by operating in one of a serial mode and a parallel mode, and a serial-parallel mode controller controlling operations of the row address decoder and the analog multiplexer as one of the serial mode and parallel mode.

In some embodiments, the digital image signal may be an image-shaped signal formed of digital signals 0 and 1 depending on whether terahertz waves detected from a detection area of the outputted terahertz waves are present or not.

In other embodiments, the terahertz wave detector may include a plurality of terahertz wave detecting devices. The terahertz wave detecting device may include an antenna detecting the terahertz waves, a switch receiving the current signal through a drain and operating according to the column selection address inputted through a gate, a capacitor whose one end is connected to a source of the switch and another is grounded, and a Shottky diode whose anode is connected to a contact point between the one end of the capacitor and an output of the antenna, the Shottky diode outputting the terahertz waves detected by the antenna through a cathode thereof.

In still other embodiments, the imaging chip may further include a plurality of buffers providing the terahertz wave detecting devices with outputs of the column address decoder, respectively and a plurality of amplifiers amplifying a plurality of outputs of the row address decoder.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating a terahertz health checker according to an embodiment of the present invention;

FIG. 2 is a view illustrating an external shape of the terahertz health checker of FIG. 1;

FIG. 3 is a view illustrating a terahertz health checker according to another embodiment of the present invention;

FIG. 4 is a view illustrating one side of the terahertz health checker of FIG. 3;

FIG. 5 is a view illustrating another side of the terahertz health checker of FIG. 3;

FIG. 6 is a view illustrating a terahertz wave detector and a readout circuit according to an embodiment of the present invention;

FIG. 7 is a view illustrating a terahertz wave detector and a readout circuit according to another embodiment of the present invention; and

FIG. 8 is a view illustrating operations of using the terahertz health checker.

### DETAILED DESCRIPTION OF PREFERRED EMBODIMENTS

Hereinafter, preferred embodiments of the present invention will be described below in more detail with reference to the accompanying drawings. In a following description, only parts necessary for understanding operations according to the embodiments will be described and a description of other parts will be omitted not to obscure the subject matters of the present invention.

The present invention provides a terahertz health checker using a terahertz band, being portable, and having high performance. The terahertz health checker uses transmission and reflection properties of terahertz waves. Terahertz waves are electronic waves having penetrability, which have excellent penetrating force due to a wavelength thereof longer than that of visible rays or infrared rays but do not cause harm to human bodies because of low energy.

Due thereto, the terahertz health checker may obtain and use digital images of terahertz waves of a signal reflected and returning through a human body.

Although the embodiments will be described based on the terahertz health checker, the embodiments may be used to detect properties of diverse targets to be detected, such as environments, objects, and animals in other fields.

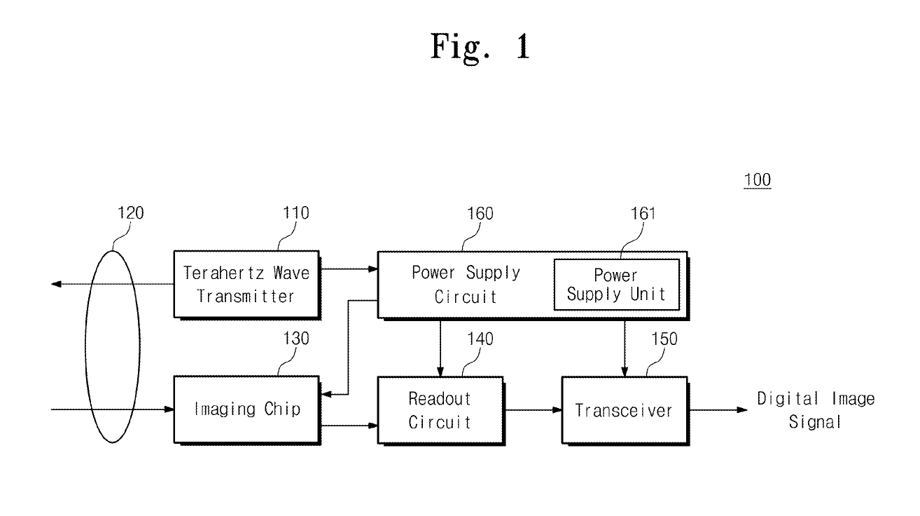

FIG. 1 is a view illustrating a terahertz health checker 100 according to an embodiment of the present invention.

Referring to FIG. 1, the terahertz health checker 100 includes a terahertz wave transmitter 110, a lens 120, an imaging chip 130, a readout circuit 140, a transceiver 150, and a power supply circuit 160.

The terahertz wave transmitter 110 may operate in response to an operation control signal, etc. and generates terahertz waves in a terahertz band. The terahertz wave transmitter 110 outputs the generated terahertz waves to the lens 120.

The lens 120 outputs inputted terahertz waves and receives terahertz waves reflected and returning from the outputted terahertz waves. The lens 120 outputs the received terahertz waves to the imaging chip 130. For example, the lens 120 includes a silicone lens, more particularly, a hyper hemispherical silicone lens or a metamaterial lens.

The imaging chip 130 includes a terahertz detector. The imaging chip 130 generates a digital image signal depending on whether a terahertz wave signal outputted by the lens 120 and reflected and returning through a target such as a human body is present or not. The imaging chip 130 may include a terahertz detector formed of a complementary metal-oxide semiconductor (CMOS) or a Schottky barrier diode (SBD) terahertz detector. The imaging chip 130 outputs the generated digital image to the readout circuit 140.

The readout circuit 140 reads out the digital image signal outputted from the imaging chip 130. The readout circuit 140 outputs the read-out digital image signal to the transceiver 150.

The transceiver 150 may be connected to an external device while being wireless or wired. When being connected by wires, the transceiver 150 outputs the digital image signal outputted by the readout circuit 140 to an output terminal such as a connecting line, a cable, and a wire. When being wirelessly connected, the transceiver 150 outputs the digital image signal as a wireless signal. For this, the transceiver 150 may be configured to support, for example, Bluetooth, wireless local area network (WLAN), wireless personal area network (WPAN), etc. However, the transceiver 150 may be configured to have various communication functions in addition to the described manners to be connected to external devices.

Also, the transceiver 150 may receive a control signal for controlling operations of the terahertz health checker 100 from the outside.

The power supply circuit 160 supplies power for allowing the terahertz health checker 100 to operate. For this, the power supply circuit 160 includes a power supply unit 161.

The power supply unit 161 includes a battery, etc. for supplying power and provides the power supply circuit 160 with operating power. On the other hand, when receiving external power, the power supply unit 161 may provide the power supply circuit 160 with the external power.

The power supply circuit 160 provides the terahertz wave transmitter 110, the imaging chip 130, the readout circuit 140, and the transceiver 150 with the operating power.

In this case, for miniaturization, the terahertz health checker 100 does not include a signal processor (not shown) for processing a digital image signal. For this, a function of the signal processor may be included in a mobile device of a user.

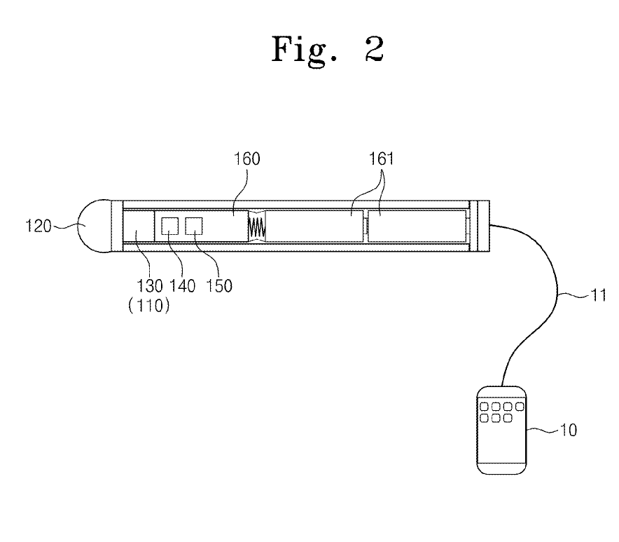

FIG. 2 is a view illustrating an external shape of the terahertz health checker 100.

Referring to FIG. 2, the terahertz health checker 100 is connected to a smart phone 10 via a connecting line 11.

Referring to FIG. 1, the terahertz health checker 100 includes the terahertz wave transmitter 110, the lens 120, the imaging chip 130, the readout circuit 140, the transceiver 150, and the power supply circuit 160.

The terahertz wave transmitter 110 outputs generated terahertz waves to the lens 120. In this case, the terahertz wave transmitter 110 may be formed in the imaging chip 130, which will be shown as an example.

The lens 120, in order to minimize an effect of a surface wave and to increase detection performance of the terahertz health checker 100, is formed of an extended hyper hemispherical silicone lens, for example, whose diameter is about 15 mm

The imaging chip 130 is aligned based on a center of the lens 120. An antenna for receiving a terahertz wave signal at the imaging chip 130 is an on-chip antenna and is extended through the lens 120. The imaging chip 130 includes a terahertz detector configured to have high input impedance within a range from about 500 to about 1000 Ω for broadband conjugation impedance matching. The imaging chip 130 outputs an obtained digital image to the readout circuit 140.

The readout circuit 140 reads out a digital image signal from the imaging chip 130 and outputs the read-out digital image signal to the transceiver 150.

The transceiver 150 outputs the digital image signal to an external device 10, for example, a smart phone through the connecting line 11.

The power supply circuit 160 supplies power supplied from the power supply unit 161 formed of two batteries to the terahertz wave transmitter 110, the imaging chip 130, the readout circuit 140, and the transceiver 150. The power supply circuit 160 may be connected to a power control button for turning on/off operation of the terahertz health checker 100.

In this case, the smart phone 10 may include a signal processor for processing the digital image signal. In this case, the signal processor may obtain desired information from the digital image signal. The smart phone 10 may output the obtained information via a display unit by using the signal processor.

Also, the smart phone 10 may receive a control command for controlling the operation of the terahertz health checker 100 from a user and may output a control signal corresponding to the control command to the terahertz health checker 100 through the connecting line 11.

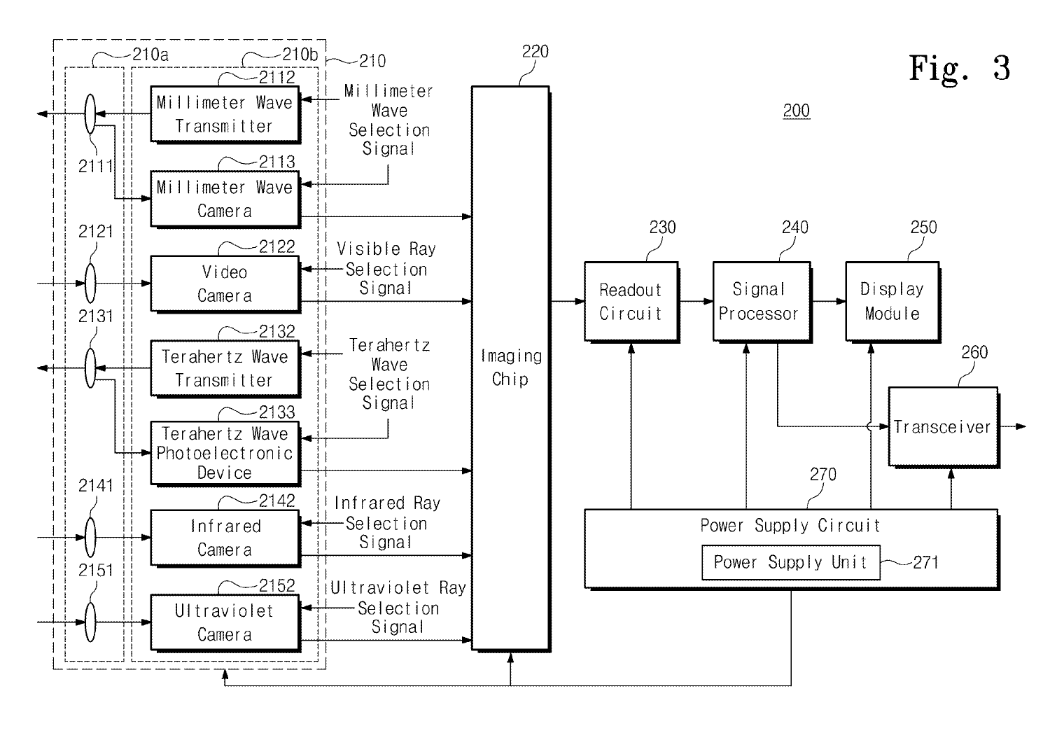

FIG. 3 is a view illustrating a terahertz health checker 200 according to another embodiment of the present invention.

Referring to FIG. 3, the terahertz health checker 200 includes a multiple camera module 210, an imaging chip 220, a readout circuit 230, a signal processor 240, a display module 250, a transceiver 260, and a power supply circuit 270.

The multiple camera module 210 includes a lens unit 210a and a camera unit 210b. In this case, the lens unit 210a is distinguished only to describe input/output of various signals and may be included in the camera unit 210b.

The lens unit 210a includes a first lens 2111, a second lens 2121, a third lens 2131, a fourth lens 2141, and a fifth lens 2151.

The camera unit 210b includes a millimeter wave transmitter 2112, a millimeter wave camera 2113, a video camera 2122, a terahertz wave transmitter 2132, a terahertz wave photoelectronic device 2133, an infrared camera 2142, and an ultraviolet camera 2152. The first lens 2111 outputs millimeter waves or receives millimeter waves reflected and returning. The first lens 2111 outputs inputted millimeter waves to the millimeter wave camera 2113.

The second lens 2121 receives visible rays. The second lens 2121 outputs inputted visible rays to the video camera 2122.

The third lens 2131 outputs terahertz waves or receives terahertz waves reflected and returning. The third lens 2131 outputs inputted terahertz waves to the terahertz wave photoelectronic device 2133.

The fourth lens 2141 receives infrared rays. The fourth lens 2141 outputs inputted infrared rays to the infrared camera 2142.

The fifth lens 2151 receives ultraviolet rays. The fifth lens 2151 outputs inputted ultraviolet rays to the ultraviolet camera 2152.

The camera unit 210b includes the millimeter wave transmitter 2112, the millimeter wave camera 2113, the video camera 2122, the terahertz wave transmitter 2132, the terahertz wave photoelectronic device 2133, the infrared camera 2142, and the ultraviolet camera 2152.

The millimeter transmitter 2112, in response to a millimeter wave selection signal, generates millimeter waves in a millimeter wave band. As an example, millimeter waves are electronic waves at from about 30 to about 300 gigahertz (GHz) and have a wavelength of from about 1 to about 10 mm. The millimeter transmitter 2112 outputs generated millimeter waves through the first lens 2111.

The millimeter wave camera 2113, in response to the millimeter wave selection signal, detects millimeter waves inputted through the first lens 2111. The millimeter wave camera 2113 outputs the inputted millimeter waves to the imaging chip 220.

The video camera 2122, in response to a visible ray selection signal, receives visible rays inputted through the second lens 2121. The video camera 2122 outputs the received visible rays to the imaging chip 220.

Terahertz wave transmitter 2132, in response to a terahertz wave selection signal, generates terahertz waves. Terahertz wave transmitter 2132 outputs the generated terahertz waves through the third lens 2131. Also, the terahertz wave transmitter 2132 time-delays and outputs some of the generated terahertz waves to a terahertz wave detector of the imaging chip 220. Through this, the terahertz wave transmitter 2132 may allow a signal of transmitted terahertz waves and a signal of received terahertz waves to be compared with each other inside the imaging chip 220.

The terahertz wave photoelectronic device 2133, in response to the terahertz wave selection signal, receives terahertz waves received through the third lens 2131. The terahertz wave photoelectronic device 2133 outputs the received terahertz waves to the imaging chip 220.

The infrared camera 2142, in response to an infrared ray selection signal, receives infrared rays inputted through the fourth lens 2141. The infrared camera 2142 outputs the received infrared rays to the imaging chip 220.

The ultraviolet camera 2152, in response to an ultraviolet ray selection signal, receives ultraviolet rays inputted through the fifth lens 2151. The ultraviolet camera 2152 outputs the received ultraviolet rays to the imaging chip 220.

The imaging chip 220 may receive signals having various waveforms and may composite detected images by using the received signals. In this case, the imaging chip 220 may generate a digital image signal with respect to the detected image based on a signal received through a target to be detected, for example, a human body. Particularly, with respect to terahertz waves, the imaging chip 220 generates a digital image signal depending on whether a terahertz wave signal reflected and returning through a target to be detected, for example, a human body. The imaging chip 220 may composite digital image signals generated with respect to at least some of millimeter waves, visible rays, terahertz waves, infrared rays, and ultraviolet rays.

Also, the imaging chip 220 may include a terahertz detector formed of a CMOS or an SBD terahertz detector. The imaging chip 220 outputs a generated digital image to the readout circuit 230.

The readout circuit 230 reads out the digital image signal outputted from the imaging chip 220. The readout circuit 230 outputs the read-out digital image signal to the signal processor 240.

The signal processor 240 processes the digital image signal outputted from the imaging chip 220. Through this, the signal processor 240 may process the digital image signal in two manners. As one manner, the signal processor 240, when the digital image signal has an image shape, synchronizes the digital image signal with a spectrum image. The signal processor 240 may perform a signal processing operation for combining a video image with a terahertz image and may use data previously stored. As another manner, the signal processor 240, when the digital image has a spectrum shape, may obtain a spectroscope image. The signal processor 240 may analyze a waveform using the spectroscope image. For this, the signal processor 240 may perform operations related to calculation, alignment, Fourier transform, spectrum analysis, spectrum response comparison, and correlation.

The signal processor 240 may include a memory (not shown) to process the digital image signal and may use data previously stored in the memory. The signal processor 240 outputs a signal-processed digital image to the display module 250.

Also, the signal processor 240 may output the signal-processed digital image to the transceiver 260.

The display module 250 may output the digital image signal-processed by the signal processor 240 via a display screen.

The transceiver 260 may be connected to an external device while being wireless or wired. When being connected while being wired, the spectroscope image is outputted to an output terminal such as a connecting line, a cable, wires, etc. While being connected wirelessly, the transceiver 260 outputs the signal-processed digital image using a wireless signal. For this, the transceiver 260 may be configured to support, for example, Bluetooth, a WLAN, a WPAN, etc. However, the transceiver 260 may be configured to have various communication functions in addition to the described manners to be connected to external devices.

On the other hand, when the connected device includes functions of the signal processor 240, the transceiver 260 may receive a digital image signal from the readout circuit 230 and may output the digital image signal to the external device.

Also, the transceiver 260 may receive a control signal for controlling operations of the terahertz health checker 200 from the external device.

The power supply circuit 270 supplies power for allowing the terahertz health checker 200 to operate. For this, the power supply circuit 270 includes a power supply unit 271.

The power supply unit 271 includes a battery, etc. for supplying power and provides the power supply circuit 270 with operating power. On the other hand, when receiving external power, the power supply unit 271 may provide the power supply circuit 270 with the external power.

The power supply circuit 270 provides the multiple camera unit 210, the imaging chip 220, the readout circuit 230, the signal processor 240, the display module 250, and the transceiver 260 with the operating power.

The imaging chips 130 and 220 included in the terahertz health checkers 100 and 200 shown in FIGS. 1 and 3, respectively, may determine a case, in which terahertz waves are reflected and return, as a digital signal 1 and may determine a case, in which terahertz waves do not return, as a digital signal 0.

For this, the terahertz health checkers 100 and 200 may obtain digital images using whether terahertz waves returning from a detection area, to which terahertz waves are emitted, are present or not. In this case, the digital image may be formed of 0 and 1 and is allowed to include information on various health statuses of the detection area.

Accordingly, the terahertz health checkers 100 and 200 may check a health status by analyzing the detected digital image using an external device such as a smart phone and a personal computer or by processing the detected digital image using a signal processor built therein.

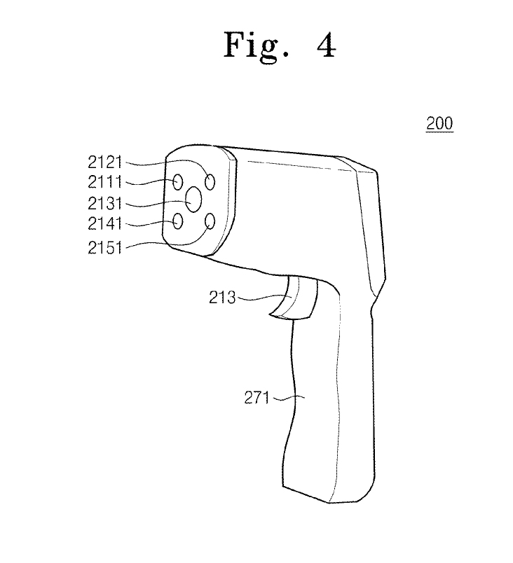

FIG. 4 is a view illustrating one side of the terahertz health checker 200.

Referring to FIG. 4, the terahertz health checker 200 may be configured to have a shape allowing the power supply unit 271, that is, a battery to be inserted into a grip. In this case, the terahertz health checker 200 includes the first to fifth lenses 2111 to 2151 in a front portion thereof. In this case, the first lens 2111 receives millimeter waves, the second lens 2121 receives visible rays, and the third lens 2131 receives terahertz waves. Also, the fourth lens 2141 receives infrared rays, and the fifth lens 2151 receives ultraviolet rays.

The terahertz health checker 200 includes a terahertz wave button 213.

The terahertz wave selection button 213 is for a detection using terahertz waves. When the terahertz wave selection button 213 is pushed, a terahertz wave selection signal is generated. The terahertz wave selection signal generated by the terahertz wave selection button 213 is provided to the terahertz wave transmitter 2132 and the terahertz wave photoelectronic device 2133.

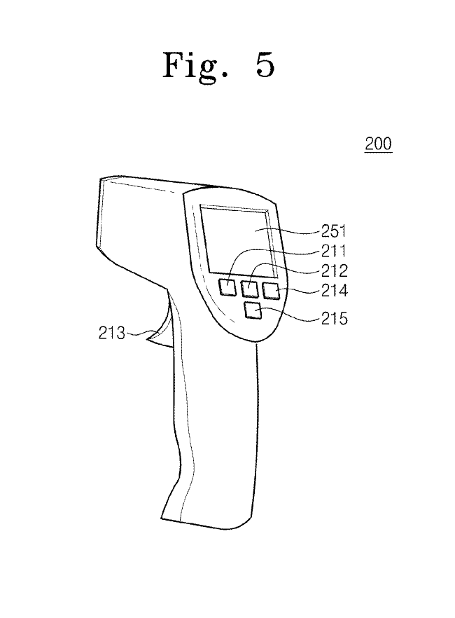

FIG. 5 is a view illustrating another side of the terahertz health checker 200.

Referring to FIG. 5, the terahertz health checker 200 includes a display screen 251 of the display module 250. The display module 250 outputs a signal-processed digital image via the display screen 251.

The terahertz health checker 200 includes a millimeter wave selection button 211, a visible ray selection button 212, an infrared ray selection button 214, and an ultraviolet ray selection button 215.

The millimeter wave selection button 211 is for detecting a target to be detected by using millimeter waves. When the millimeter wave selection button 211 is pushed, a millimeter wave selection signal is generated. The millimeter wave selection signal generated by the millimeter wave selection button 211 is provided to the millimeter wave transmitter 2112 and the millimeter wave camera 2113.

The visible ray selection button 212 is for detecting a target to be detected by using visible rays. When the visible ray selection button 212 is pushed, a visible ray selection signal is generated. The visible ray selection signal generated by the visible ray selection button 212 is provided to the video camera 2122.

The infrared ray selection button 214 is for detecting a target to be detected by using infrared rays. When the infrared ray selection button 214 is pushed, an infrared ray selection signal is generated. The infrared ray selection signal generated by the infrared ray selection button 214 is provided to the infrared camera 2142.

The ultraviolet ray selection button 215 is for detecting a target to be detected by using ultraviolet rays. When the ultraviolet ray selection button 215 is pushed, an ultraviolet ray selection signal is generated. The ultraviolet ray selection signal generated by the ultraviolet ray selection button 215 is provided to the ultraviolet camera 2152.

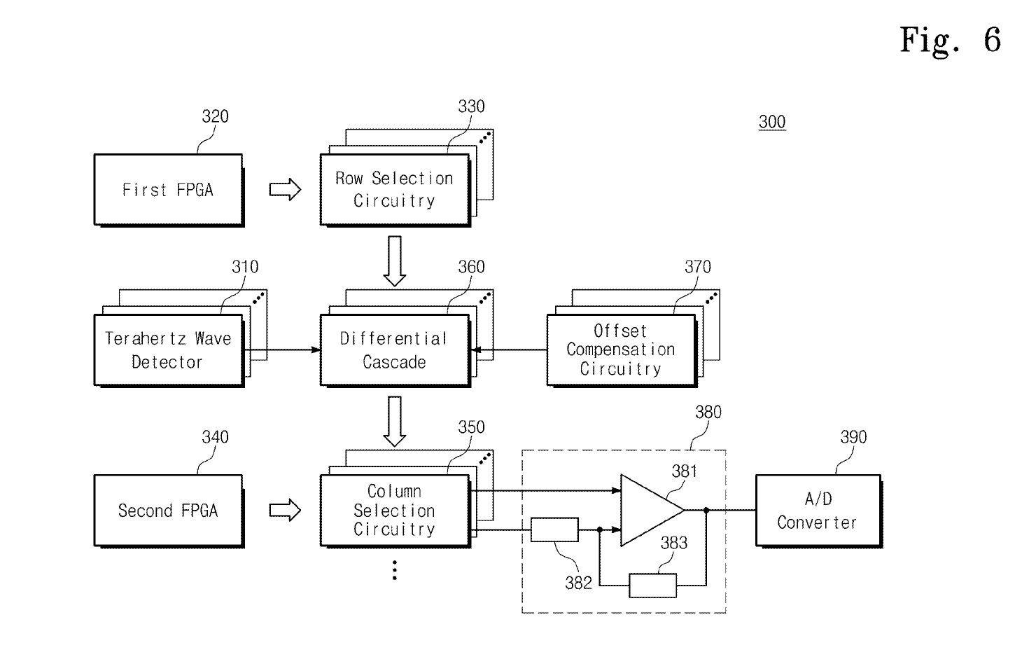

FIG. 6 is a view illustrating an imaging chip 300 according to an embodiment of the present invention.

Referring to FIG. 6, the imaging chip 300 includes a terahertz wave detector 310, a first field programmable gate array (FPGA) 320, a row selection circuitry 330, a second FPGA 340, a column selection circuitry 350, a differential cascade 360, an offset compensation circuitry 370, a sample hold amplifier 380, and an analog/digital (A/D) converter 390.

The terahertz wave detector 310 detects a plurality of terahertz wave signals inputted through a lens.

The first FPGA 320 programs and stores a matrix. The first FPGA 320 generates a row address by using information on the programmed matrix. As an example, the first FPGA 320 may generate a row selection address 0-31 of 32 bits. The first FPGA 320 outputs the generated row selection address to the row selection circuitry 330.

The row selection circuitry 330 selects row bits corresponding to the detected terahertz waves based on the row selection address. The row selection circuitry 330 outputs the selected row bits to the differential cascade 360.

The second FPGA 340 programs and stores a matrix. The second FPGA 340 generates a column address by using information on the programmed matrix. As an example, the second FPGA 340 may generate a column selection address 0-31 of 32 bits. The second FPGA 340 outputs the generated column selection address to the column selection circuitry 350.

The column selection circuitry 350 selects column bits corresponding to the detected terahertz waves based on the column selection address. The column selection circuitry 350, for example, may be formed of 5 bits. A single column of the column selection circuitry 350 is biased toward time.

The differential cascade 360 is biased by a voltage of an antenna common node. The single column is biased toward time by the column selection circuitry 350. Through this, the differential cascade 360 matches the detected terahertz waves with the row bits and outputs the same to the column selection circuitry 350. The differential cascade 360, for example, selects a single pixel capable of being buffered by a single gain amplifier, that is, the sample hold amplifier 380 having a gain band of about 0.4 megahertz (MHz). For example, the differential cascade 360 may perform parallel processing of 1024 pixels while activating the single column formed of 32 bits.

The offset compensation circuitry 370 compensates an offset of a signal according to detecting terahertz waves by using the differential cascade 360.

On the other hand, the column selection circuitry 350 matches a detection signal matched with the row bits with a column signal and outputs the same to the sample hold amplifier 380.

The sample hold amplifier 380 amplifies and outputs a signal outputted through the column selection circuitry 350 to the A/D converter 390. In response to external control, when a switching off signal is inputted, the sample hold amplifier 380 stores the switching off signal, and when a switching on signal is inputted, the sample hold amplifier 380 outputs the switching on signal to the A/D converter 390.

The sample hold amplifier 380 includes an amplifier 381, a first gain controller 382, and a second gain controller 383.

The amplifier 381 amplifies an inputted signal and outputs the amplified signal to the A/D converter 390.

The first gain controller 382 is connected to one of input terminals of the amplifier 381 and controls gains.

The second gain controller 383 is connected between an output of the first gain controller 382 and an output of the amplifier 381 and controls gains.

The A/D converter 390 converts the signal amplified by the sample hold amplifier 380 into a digital signal and outputs the digital signal.

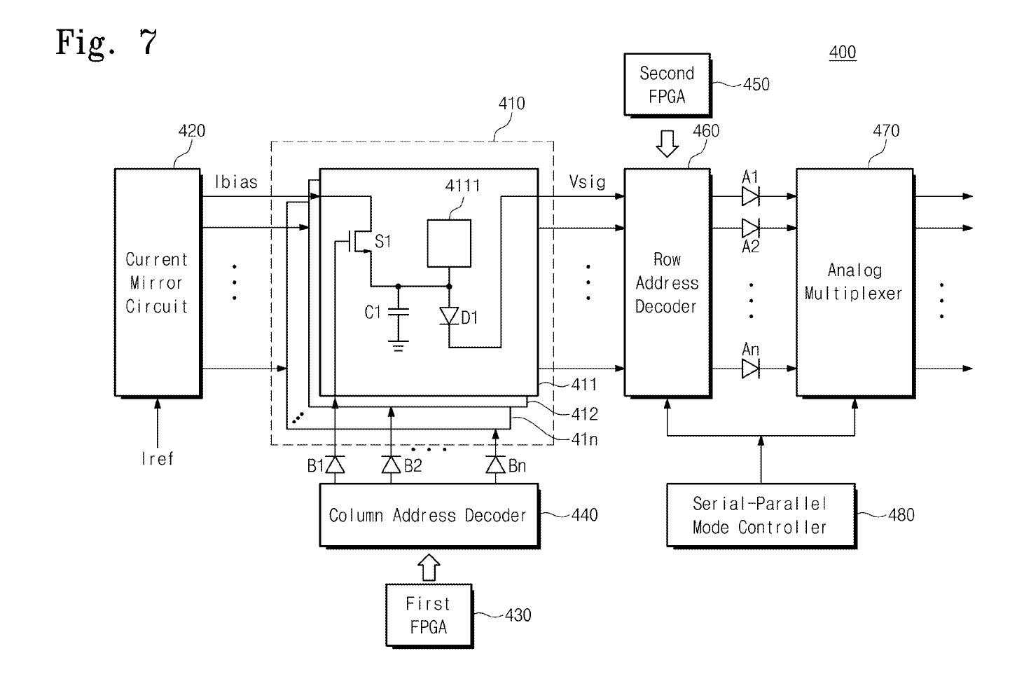

FIG. 7 is a view illustrating an imaging chip 400 according to another embodiment of the present invention.

Referring to FIG. 7, the imaging chip 400 includes a terahertz wave detector 410, a current mirror circuit 420, a first FPGA 430, a column address decoder 440, a second FPGA 450, a row address decoder 460, an analog multiplexer 470, and a serial-parallel mode controller 480.

In this case, the imaging chip 400 includes a terahertz wave detector 410 formed of a CMOS SBD.

The terahertz wave detector 410 detects a plurality of terahertz waves inputted through a lens. The terahertz wave detector 410 may be formed of a shape connecting a plurality of terahertz wave detecting devices 411, 412, . . . , and 41n.

A terahertz wave detecting device 411 includes an antenna 4111, a switch S1, a capacitor C1, and a Shottky diode D1.

The antenna 4111 receives a terahertz wave signal inputted through the lens.

The switch S1 switches according to a column selection signal outputted from the column address decoder 440. The switch S1 may be formed of a transistor, and a gate thereof receives the column selection signal through a first buffer B1 connected to the column address decoder 440. A source of the switch S1 is connected to a contact point between one end of the capacitor C1 and an anode of the Shottky diode D1. A drain of the switch 51 receives a current signal Ibias outputted from the current mirror circuit 420.

The one end of the capacitor C1 is connected to a contact point between the source of the switch S1 and the anode of the Shottky diode D1 and another is grounded.

The anode of the Shottky diode D1 is connected to the one end of the capacitor C1 and receives a signal detected by the antenna 4111. A cathode of the Shottky diode D1 is connected to an input terminal of the row address decoder 460 and outputs a voltage signal Vsig according to terahertz detection.

The current mirror circuit 420 receives a reference current Iref, generates a plurality of current signals Ibias having same current values from the reference current Iref, and outputs the plurality of current signals Ibias to the plurality of terahertz wave detecting devices 411, 412, and 41n, respectively. Through this, the current mirror circuit 420 provides the terahertz wave detector 410 with the current signals Ibias for detecting terahertz waves.

The first FPGA 430 programs and stores a matrix. The first FPGA 430 generates a column selection address by using information on the programmed matrix. As an example, the first FPGA 430 may generate a column selection address 0-31 of 32 bits. The first FPGA 430 outputs the generated column selection address to the column address decoder 440.

The column address decoder 440 selects column bits corresponding to detected terahertz waves based on the column selection address. Information on the selected column bits is outputted to each of the terahertz wave detecting devices 411, 412, . . . , and 41n through a plurality of buffers B1, . . . , and Bn connected to the column address decoder 440.

The second FPGA 450 programs and stores a matrix. The second FPGA 450 generates a row selection address by using information on the programmed matrix. As an example, the second FPGA 450 may generate a row selection address 0-31 of 32 bits. The second FPGA 450 outputs the generated row selection address to the row address decoder 460.

The row address decoder 460 matches a signal Vsig outputted from the terahertz wave detector 410 according to inputted row selection address with selected row selection address and outputs the same to a plurality of amplifiers A1, . . . , and An. In this case, the signal outputted from the terahertz wave detector 410 is a signal selected and outputted according to the row selection address. In a serial mode, an image output operates with small noise. In a parallel mode, the image output operates at a high speed.

The analog multiplexer 470 combines signals outputted through the amplifiers A1, . . . , and An and operates in one of a serial mode and a parallel mode. In the serial mode, the analog multiplexer 470 is combined with the amplifiers A1, . . . , and An and connects all inputs of the amplifiers A1, . . . , and An to a pixel whose address is selected.

Through this, the analog multiplexer 470 multiplexes and outputs the detected terahertz waves.

The serial-parallel mode controller 480 may provide the row address decoder 460 and the analog multiplexer 470 with a mode control signal for controlling to operate in one of a serial mode and a parallel mode.

The imaging chips 300 and 400 shown in FIGS. 6 and 7 may be used as the imaging chips 130 and 220 shown in FIGS. 1 to 3.

Also, the imaging chips 300 and 400 decode a detected signal based on a column and row with respect to a detection area, thereby allowing the terahertz health checkers 100 and 200 to obtain a digital signal having an image shape using detected terahertz waves.

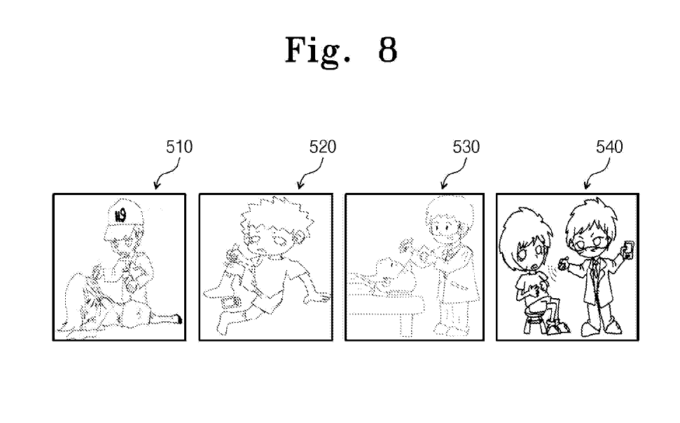

FIG. 8 is a view illustrating operations of using the terahertz health checker.

Referring to FIG. 8, in 510, a pulse and temperature of a patient are checked using the terahertz health checker.

In 520, a fracture is checked using the terahertz health checker. In 530, teeth and skin are checked using the terahertz health checker.

In 540, breasts of a patient are checked using the terahertz health checker.

In FIG. 8, there are shown examples of using the terahertz health checker. In addition thereto, the terahertz health checker may be used to check various statuses of patients or nonpatients.

The terahertz health checker according to the present embodiment has measurement performance with high resolution by image-scattering a detected signal by using terahertz waves. Also, the terahertz health checker may digitally image a detection signal by using terahertz waves, thereby having a miniaturized size.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A terahertz health checker comprising:
a terahertz wave transmitter generating terahertz waves in a terahertz band;
a lens outputting the terahertz waves and receiving terahertz waves reflected from the outputted terahertz waves;
an imaging chip connected to the lens, detecting the received terahertz waves, and generating a digital image signal based on the detected terahertz waves;
a readout circuit reading out the digital image signal; and
a transceiver outputting the read-out digital image signal to the outside.

2. The terahertz health checker of claim 1, wherein the digital image signal is an image-shaped signal formed of digital signals 0 and 1 depending on whether terahertz waves detected from a detection area of the outputted terahertz waves are present or not.

3. The terahertz health checker of claim 1, further comprising a power supply circuit for supplying operating power to the terahertz transmitter, the imaging chip, the readout circuit, and the transceiver.

4. The terahertz health checker of claim 1, further comprising:
a millimeter wave generator for generating and transmitting a millimeter wave;
a lens outputting the generated millimeter wave and receiving millimeter wave corresponding to the outputted millimeter wave; and
a millimeter wave camera outputting the received millimeter wave to the imaging chip.

5. The terahertz health checker of claim 1, further comprising:
a lens for receiving visible rays; and
a video camera outputting the received visible rays to the imaging chip.

6. The terahertz health checker of claim 1, further comprising:
a lens for receiving infrared rays; and
an infrared camera outputting the received infrared rays to the imaging chip.

7. The terahertz health checker of claim 1, further comprising:
a lens for receiving ultraviolet rays; and
an ultraviolet camera outputting the received ultraviolet rays to the imaging chip.

8. The terahertz health checker of claim 1, further comprising:
a signal processor processing the digital image signal; and
a display module displaying the signal-processed digital image signal.

9. The terahertz health checker of claim 1, wherein the imaging chip comprises:
a first field programmable gate array (FPGA) generating a row address;
a row selection circuitry generating row bits using the row address;
a terahertz wave detector detecting the terahertz waves;
a differential cascade matching the detected terahertz waves with the row bits and outputting the same;
a second FPGA generating a column address;
a column selection circuitry generating column bits using the column address, matching the terahertz waves matched with the row bits with the column bits, and output the same;
a sample hold amplifier amplifying a terahertz wave signal matched with the column bits and row bits and outputting the amplified signal using a holding operation according to an external control signal; and
an A/D converter converting the amplified signal into a digital signal and outputting the digital signal.

10. The terahertz health checker of claim 9, wherein the imaging chip further comprises an offset compensation circuitry compensating the differential cascade with an offset of the detected terahertz wave signal.

11. The terahertz health checker of claim 1, wherein the imaging chip comprises:
a first FPGA generating a column address;
a column address decoder generating a column selection address using the column address;
a current mirror circuit receiving a reference current and providing a current signal for detecting terahertz waves;
a terahertz wave detector detecting the received terahertz waves based on the current signal and the column selection address;
a second FPGA generating a row address;
a row address decoder generating a row selection address using the row address and outputting the detected terahertz waves using the row selection address;
an analog multiplexer multiplexing and outputting the outputted terahertz waves by operating in one of a serial mode and a parallel mode; and
a serial-parallel mode controller controlling operations of the row address decoder and the analog multiplexer as one of the serial mode and parallel mode.

12. The terahertz health checker of claim 11, wherein the terahertz wave detector comprises a plurality of terahertz wave detecting devices,
wherein the terahertz wave detecting device comprises:
an antenna detecting the terahertz waves;
a switch receiving the current signal through a drain and operating according to the column selection address inputted through a gate;
a capacitor whose one end is connected to a source of the switch and another is grounded; and
a Shottky diode whose anode is connected to a contact point between the one end of the capacitor and an output of the antenna, the Shottky diode outputting the terahertz waves detected by the antenna through a cathode thereof.

13. The terahertz health checker of claim 12, wherein the imaging chip further comprises:
a plurality of buffers providing the terahertz wave detecting devices with outputs of the column address decoder, respectively; and
a plurality of amplifiers amplifying a plurality of outputs of the row address decoder.

14. A terahertz health checker comprising:
a lens receiving terahertz waves;
an imaging chip connected to the lens, detecting the received terahertz waves, and generating a digital image signal based on the detected terahertz waves; and
a readout circuit reading out the digital image signal,
wherein the imaging chip comprises:
a first FPGA generating a row address;
a row selection circuitry generating row bits using the row address;
a terahertz wave detector detecting the terahertz waves;
a differential cascade matching the detected terahertz waves with the row bits and outputting the same;
a second FPGA generating a column address;
a column selection circuitry generating column bits using the column address, matching the terahertz waves matched with the row bits with the column bits, and output the same;
a sample hold amplifier amplifying a terahertz wave signal matched with the column bits and row bits and outputting the amplified signal using a holding operation according to an external control signal; and
an A/D converter converting the amplified signal into a digital signal and outputting the digital signal.

15. The terahertz health checker of claim 14, wherein the digital image signal is an image-shaped signal formed of digital signals 0 and 1 depending on whether terahertz waves detected from a detection area of the outputted terahertz waves are present or not.

16. The terahertz health checker of claim 14, wherein the imaging chip further comprises an offset compensation circuitry compensating the differential cascade with an offset of the detected terahertz wave signal.

17. A terahertz health checker comprising:
a lens receiving terahertz waves;
an imaging chip connected to the lens, detecting the received terahertz waves, and generating a digital image signal based on the detected terahertz waves; and
a readout circuit reading out the digital image signal,
wherein the imaging chip comprises:
a first FPGA generating a column address;
a column address decoder generating a column selection address using the column address;
a current mirror circuit receiving a reference current and providing a current signal for detecting terahertz waves;
a terahertz wave detector detecting the received terahertz waves based on the current signal and the column selection address;
a second FPGA generating a row address;
a row address decoder generating a row selection address using the row address and outputting the detected terahertz waves using the row selection address;
an analog multiplexer multiplexing and outputting the outputted terahertz waves by operating in one of a serial mode and a parallel mode; and
a serial-parallel mode controller controlling operations of the row address decoder and the analog multiplexer as one of the serial mode and parallel mode.

18. The terahertz health checker of claim 17, wherein the digital image signal is an image-shaped signal formed of digital signals 0 and 1 depending on whether terahertz waves detected from a detection area of the outputted terahertz waves are present or not.

19. The terahertz health checker of claim 17, wherein the terahertz wave detector comprises a plurality of terahertz wave detecting devices,
wherein the terahertz wave detecting device comprises:
an antenna detecting the terahertz waves;
a switch receiving the current signal through a drain and operating according to the column selection address inputted through a gate;
a capacitor whose one end is connected to a source of the switch and another is grounded; and
a Shottky diode whose anode is connected to a contact point between the one end of the capacitor and an output of the antenna, the Shottky diode outputting the terahertz waves detected by the antenna through a cathode thereof.

20. The terahertz health checker of claim 17, wherein the imaging chip further comprises:
a plurality of buffers providing the terahertz wave detecting devices with outputs of the column address decoder, respectively; and
a plurality of amplifiers amplifying a plurality of outputs of the row address decoder.
